(19) United States
(12) Patent Application Publication
(10) Pub. No.: US 2004/0203804 A1
(43) Pub. Date: Oct. 14, 2004

(54) Reduction of intermodualtion product interference in a network having sectorized access points

(75) Inventor: Andria Van Der Merwe, Dallas, TX (US)

Correspondence Address: WOOD, HERRON & EVANS, LLP, 2700 CAREW TOWER, 441 VINE STREET, CINCINNATI, OH, 45202, US

(73) Assignee: Andrew Corporation, Orland Park, IL

(21) Appl. No.: 10/336,267

(22) Filed: Jan. 3, 2003

(51) Int. Cl. H04Q 7/20; H04B 15/00

(52) U.S. Cl. 455/446; 455/63.1

(57) ABSTRACT

A wireless network having a sectorized wireless access points defined by respective directional antennas that operate using equally spaced carrier frequencies, the carrier frequencies assigned to the sectors in individual access points to reduce intermodulation product interference among the carrier frequencies within the wireless access point.

### CROSS-REFERENCE TO RELATED APPLICATIONS

This application is related to the co-pending U.S. patent application Ser. No. 10/244,912, entitled MULTI-BAND WIRELESS ACCESS POINT, filed on Sep. 16, 2002 by Mano D. Judd et al.

### FIELD OF THE INVENTION

This invention generally relates to the provision of wireless network services and specifically to networks employing multiple co-located radio frequency (RF) receivers using equally spaced carrier frequencies.

### BACKGROUND OF THE INVENTION

In the provision of communication services within a wireless local area network (WLAN), the area is served by multiple interconnected wireless access points located throughout the area forming the network. Such a network may be installed in airports, shopping malls, office buildings, hospitals, and factories, as well as other locations where wireless accessibility may be desired. A wireless access point typically utilizes an omni-directional antenna that communicates with wireless devices, such as computers containing a network interface card (NICs) configured for WLAN communications. Telephones, paging devices, personal data assistants (PDAs), notebooks, and pocket notebooks, as well as other wireless devices, may also communicate using the network. The layout or configuration of the network, i.e., the spacing or separation of the wireless access points, may be determined by the data rate of communications between the network and the wireless devices, the modulation scheme used in those communications, and/or the propagation of communication signals from the wireless access points.

The Institute of Electrical and Electronics Engineers (IEEE) has promulgated three notable standards or communications protocols for WLANs. The first communications protocol, known as 802.11b, was based on proprietary or 2 Megabit per second (Mbps) products utilizing an unlicensed portion of the spectrum found at approximately 2.4 Gigahertz (GHz). The 802.11b communications protocol specifies a modulation scheme known as complementary code keying (CKK) to encode the wireless data in a format that fits within the bandwidth allotted under Federal Communications Commission (FCC) 802.11 direct-sequence spread-spectrum (DSSS) rules. CKK allows communications at data rates of up to 11 Mbps. Although the majority of WLANs in existence today are consistent with the 802.11b communications protocol, 802.11b WLANs are of limited utility since their speed is approximately that of a 10 Mbps Ethernet link.

Concurrent with the approval of the original 802.11b communications protocol, the IEEE approved the 802.11a communications protocol. The 802.11a communications protocol uses a modulation scheme referred to as orthogonal frequency division multiplexing (OFDM) to achieve a data rate of 54 Mbps through a portion of the spectrum located at approximately 5 GHz. A problem facing wireless network providers is that 802.11b and 802.11a WLANs were never intended to be compatible.

More recently, the 802.11g communications protocol has been promulgated, allowing data rates up to 54 Mbps within the 2.4 GHz band using OFDM.

Faced with the evolution of multiple communications protocols and a demand for increased data rates from subscribers, it may be desirable for a wireless network provider to upgrade an existing network, such as an 802.11b WLAN, to provide support for a newer communications protocol, such as 802.11a and/or 802.11g. Moreover, it may be desirable to support future communications protocols having increased data rates. The cross-referenced application entitled MULTI-BAND WIRELESS ACCESS POINT, U.S. patent application Ser. No. 10/244,912, filed on Sep. 16, 2002 by Mano D. Judd et al., describes how such may be done using sectorized antennas, and is incorporated herein by reference in its entirety.

However, a concern in supporting more than one communications protocol is that when multiple radio frequency (RF) receivers are co-located using equally spaced carriers in a WLAN, intermodulation products are often generated due to non-linearities in the receiver front-ends. Moreover, such intermodulation products often fall on desired frequencies so that filtering may not be used to eliminate the intermodulation products. Further, intermodulation product levels may be higher than the level of desired communications signals. In such an instance, the intermodulation products dominate desired received signal energy.

Numerous systems and/or methods are known for dealing with interference when cellular base stations are equipped with omni-directional antennas, the allocation of channels to base stations in such systems being directed at reducing interference between channels, or co-channel interference as it is sometimes referred to. Although such allocation patterns might be applied to a WLAN containing access points having sectorized antennas, such allocation patterns fail to take advantage of channel reuse that directional antennas offer. Other systems that do address the use of directional antennas have certain additional drawbacks.

For example, one approach that does reuse channels in allocation involves a cellular system having sectorized base stations. In this system, the available communications channels are divided into subsets and the base stations are arranged into clusters. Within each cluster, several criteria must be adhered to. First, the number of channel subsets is equal to the number of base stations. Second, the number of channel subsets must be greater than the number of sectors in each base station. Third, the number of channel subsets must not be a multiple of the number of sectors in each base station. Each channel subset is then allocated once in the direction of each sector, and the allocation pattern is not repeated within the cluster. Although such an approach takes advantage of the channel reuse that directional antennas offer, such an approach is focused on co-channel interference and not intermodulation products resulting from non-linearities in the receiver front-ends.

In another approach that does address intermodulation in allocating channels in a cellular system, the system organizes and stores usable channels in groups. The groups are designed to include the maximum number of channels that do not intermodulate with each other. Based on the current radio frequency environment, a channel is selected for transmission from one of the groups, those channels not selected being stored as an invalid channel. Thus, intermodulation among the channels is reduced based on the groupings. Although such an approach may be applicable to a WLAN containing access points having sectorized antennas, such an approach is complex and costly, due to in large part to the adaptive nature.

Therefore, there is still a need for a way of reducing intermodulation products in a system having multiple multi-band wireless access point for use in a wireless network.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a diagrammatic top view of a first embodiment of a wireless area network including three access points, each with three sectors, and operating using frequency planning in accordance with principles of the present invention;

FIG. 2 is a diagrammatic top view of a second embodiment of a wireless area network including three access points, each with four sectors, and operating using frequency planning in accordance with principles of the present invention; and,

FIG. 3 is a flow chart of an algorithm that may be used for frequency planning in the embodiments of FIGS. 1 and 2.

### DETAILED DESCRIPTION

The present invention addresses the above-noted desires and needs in the art by providing frequency planning or assignment with sectorization to reduce intermodulation distortion (IMD) to acceptable levels. Such an approach, though not adaptive in nature, takes advantage of propagation losses of transmitted signals.

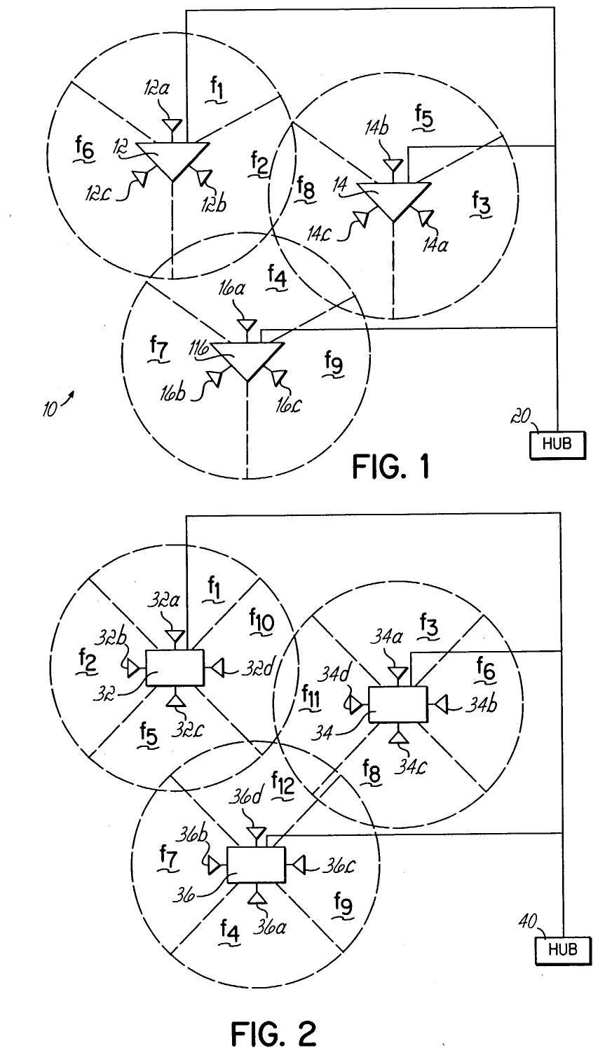

Referring first to FIG. 1, a diagrammatic top view of a first embodiment 10 of a wireless area network (WLAN) operating using frequency planning in accordance with principles of the present invention is illustrated. WLAN 10 comprises a first plurality of access points (M_{AP}, M_{AP}=3) 12, 14, and 16, each access point having second pluralities of sectors (Nₛ, Nₛ=3) designated as f₁, f₂, and f₆; f₃, f₅, and f₈; f₄, f₇, and f₉, respectively. Sectors f₁-f₉ associated with each access point 12, 14, and 16 are defined by respective directional antennas 12a-c, 14a-c, and 16a-c. Thus, in WLAN 10, M_{AP}=3, Nₛ=3, and there are M_{AP}×Nₛ, or 9 sectors corresponding to 9 equally spaced carrier frequencies, also denoted by f₁-f₉.

If the equally spaced carrier frequencies are assigned to sectors randomly without using principles of the present invention, it is possible for combinations of transmissions using such carrier frequencies, directed in substantially the same direction, to mix. In such a scenario, intermodulation products may be generated. Moreover, such intermodulation products may occur at, or fall on or near, a frequency f used for reception in another sector, at which the intermodulation product may be directed. Although all intermodulation is inherently undesired, such intermodulation that appears as a possible carrier signal is particularly undesirable. Therefore, intermodulation or interference as referred to herein refers generally to the mixing of two or more carrier or other frequencies that produce another resultant interference frequency that occurs at the frequency of, or falls on or near, another carrier frequency in the system. It is therefore such intermodulation interference to which the invention is generally directed. Performing frequency planning or assigning frequencies to sectors prior to operation using the principles of the present invention reduces such intermodulation distortion products and other related interferences to acceptable levels.

For example, frequency planning may be used for access points 12, 14, and 16 operating using the 802.11a communications protocol. In such an embodiment, sectors f₁-f₉ may use equally spaced carrier frequencies with a frequency increment of 20 megahertz (MHz). Thus, for example, carrier frequencies of 5.180, 5.200, 5.220, 5.240, 5.260, 5.280, 5.300, 5.320, and 5.340 gigahertz (GHz) may be assigned to sectors f₁-f₉, respectively.

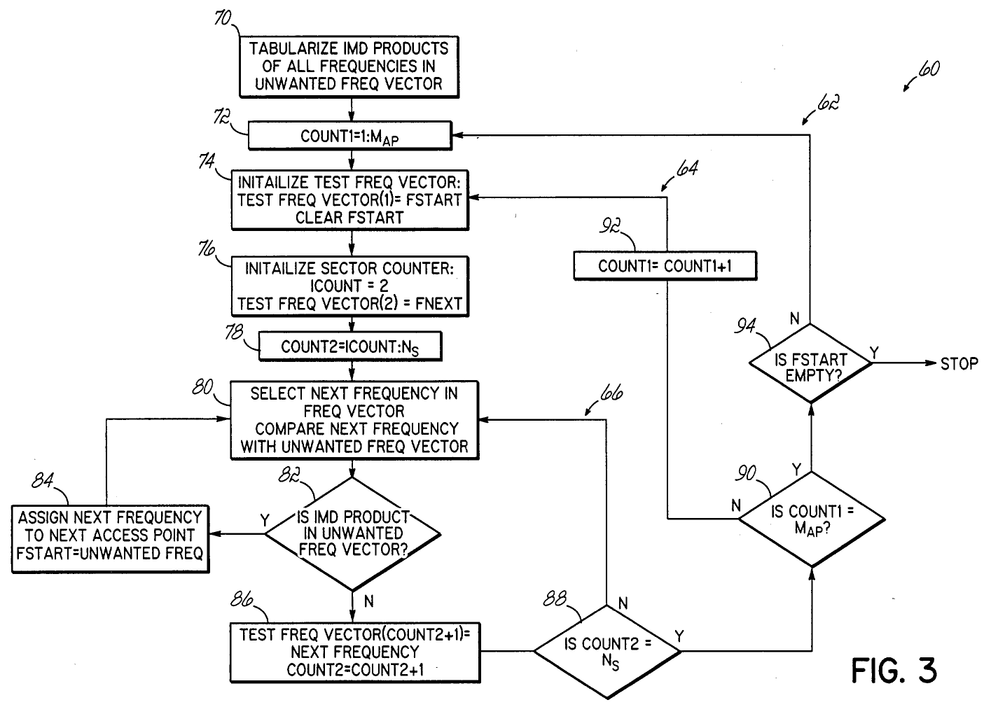

Those skilled in the art will appreciate that practically any frequency increment and any frequency band may be used as desired for assignment to the sectors without departing from the present invention. Further, practically any modulation scheme that is susceptible to intermodulation, e.g., frequency modulation, time division multiple access (TDMA), etc., may also be used and would benefit from the present invention. One exemplary method of assigning frequencies, or frequency planning, in WLAN 10 will be discuss hereinafter in conjunction with FIG. 3. The access points and their respective antennas 12a-c, 14a-c, and 16a-c are coupled to an appropriate hub, or switch, 20 or other component for operably coupling the access points to a network (not shown). Generally, the hub 20 is located remotely from the access points 12, 14, 16 and is connected via wired or wireless connections. The hub 20 will generally include the appropriate electronics for interfacing the traffic from the access points with the appropriate networks. The hub 20 in turn may be coupled by wired or wireless connections to other network electronics (not shown) remote from the facility housing the WLAN, such as remote from the building in which the access points are located.

Referring now to FIG. 2, a diagrammatic top view of a second embodiment 30 of a WLAN operating using frequency planning in accordance with principles of the present invention is illustrated. WLAN 30 also comprises a first plurality of access points (M_{AP}, M_{AP}=3) 32, 34, and 36, each having second respective pluralities of sectors (Nₛ, Nₛ=4) f₁, f₂, f₅, and f₁₀; f₃, f₆, f₈, and f₁₁; f₄, f₇, f₉, and f₁₂. Sectors f₁-f₁₂ within each access point 32, 34, and 36 are defined by respective directional antennas 32a-d, 34a-d, and 36a-d. Thus, in WLAN 30, M_{AP}=3, Nₛ=4, and there are M_{AP}×Nₛ, or 12 sectors corresponding to 12 equally spaced frequencies, also denoted by f₁-f₁₂.

In an example, frequencies f₁-f₁₂ may also be equally spaced carrier frequencies with a frequency increment of 20 MHz consistent with the 802.11a communications protocol. Thus, carrier frequencies f₁-f₁₂ may be 5.180, 5.200, 5.220, 5.240, 5.260, 5.280, 5.300, 5.320, 5.340, 5.360, 5.380, and 5.400 GHz, respectively. The access points 32, 34, 36 are also coupled to an appropriate hub 40 for connection to a network as discussed above with respect to FIG. 1.

Based on the embodiments 10 and 30 of FIGS. 1 and 2, those skilled in the art will appreciate that a WLAN may include practically any number of access points, each having practically any number of sectors. Again, one method of assigning frequencies f, or frequency planning, in WLANs 10, 30 will be discussed hereinafter in conjunction with FIG. 3.

Referring now to FIG. 3, a flow chart for an algorithm 60 that may be used for frequency planning in the embodiments of FIGS. 1 and 2 is illustrated. More specifically, algorithm 60 may be used to assign frequencies f₁-f₉ in the embodiment of FIG. 1 and frequencies f₁-f₁₂ in the embodiment of FIG. 2 in accordance with the principles of the present invention. Moreover, those skilled in the art will appreciate that algorithm 60 may also be used for frequency planning or to assign frequencies to sectors in other access points or cells in other networks.

The flow chart illustrates the steps to assign successive carrier frequencies to a WLAN comprised of a first plurality of access points (M_{AP}), each access point having respective second pluralities of sectors (Nₛ). Algorithm 60 designates carrier frequencies for sectors such that intermodulation products within each access point and interferences due to such intermodulation products are reduced to acceptable levels. Algorithm 60 does so by taking each access point in turn, assigning carrier frequencies to each sector in that access point, before moving on to subsequent access points. Thus, algorithm 60 is directed to assigning carrier frequencies within individual access points to reduce and/or avoid intermodulation interference within those specific individual access points.

The present invention is directed to addressing the effects of intermodulation products at an access point, which are caused by the carrier frequencies at that access point. Generally, the concern regarding intermodulation interference between adjacent access points is addressed by the physical spacing between access points, i.e., spatial diversity. Such spacing, allows propagation losses to attenuate transmissions from one access point to such a degree that significant intermodulation issues at one access point will not significantly affect transmissions at another access point. Thus, for example, a particular carrier frequency not suitable for use in one access point may be suitable for use in an adjacent access point. To thereby address such issues in accordance with the principles of the invention, algorithm 60 comprises three interconnected loops 62, 64, 66, each loop performing a distinct function.

However, prior to discussing the operation of loops 62, 64, and 66, the definition of key terms as they are used in algorithm 60 may be of note. A vector or array or listing containing all carrier frequencies available for use in the system is denoted as “FREQ VECTOR”. A vector or array or listing containing all intermodulation products between all carrier frequencies in FREQ VECTOR that generally fall on another carrier frequency is denoted as “UNWANTED FREQ VECTOR”. Similarly, a vector or array or listing containing the selected carrier frequencies for a particular access point in the system is denoted as “TEST FREQ VECTOR”.

Further, “Access Point M_{AP}” denotes the number of access points in a WLAN. Similarly, “Sector Nₛ” denotes the number of sectors in each access point in the WLAN. “FSTART” is randomly selected and is preferably the lowest carrier frequency available in FREQ VECTOR. “FNEXT” is the next successive non-selected carrier frequency. Both FSTART and FNEXT are automatically updated in algorithm 60.

Turning now to the loops 62, 64 and 66, outer loop 62 keeps track of the access point number that is currently being setup with carrier frequency assignments, denoted as COUNT1 and initializes COUNT1. Loop 64 initializes the TEST FREQ VECTOR for the particular access point and also keeps track of the particular access point number, denoted as COUNT1. Inner loop 66 selects the carrier frequencies to be assigned to the sectors (Nₛ) of the current access point.

More specifically, algorithm 60 begins in block 70 wherein undesired intermodulation products of all carrier frequencies, i.e., combinations of two carrier frequencies that give rise to intermodulation products that occur at other carrier frequencies, are tabularized in UNWANTED FREQ VECTOR. Outer loop 62 is then entered in block 72. In block 72, COUNT1, representative of the number of access points, is set to one and incremented until reaching the number of total access points in the WLAN, or MAP. Thus, loop 62 keeps track of the access point number, or COUNT1.

Next, in block 74, loop 64 is entered and TEST FREQ VECTOR is initialized, inputting the carrier frequency in FSTART into the TEST FREQ VECTOR and then subsequently clearing FSTART. Next, in block 76, the sector counter is initialized, setting an internal count setting or ICOUNT equal to 2, and inputting the next carrier frequency in FNEXT into the TEST FREQ VECTOR. TEST FREQ VECTOR now contains the first two carrier frequencies (FSTART and FNEXT), each capable of generating intermodulation products with a third carrier frequency. Next, in block 78, COUNT2 is set equal to ICOUNT, whereby COUNT2 will then be incremented up from ICOUNT until it reaches Sector Nₛ. Therefore, loop 64 initializes the TEST FREQ VECTOR for the particular access point and also keeps track of the sector number, or COUNT2 for that access point, so that all the sectors for a particular access point are addressed.

Next, inner loop 66 is entered in block 80. Inner loop 66 selects the next carrier frequencies to be assigned to the remaining sectors of the current access point. The next chosen frequency for a sector must be chosen, in accordance with the invention, to avoid intermodulation problems with any of the currently selected sector carrier frequencies. Any unselected carrier frequency is tested against all the currently selected carrier frequencies such that problems with intermodulation products are reduced. More specifically, when the unselected carrier frequency being considered would generate an undesired intermodulation product with respect to the currently existing carrier frequencies, that unselected carrier frequency is stored in variable FSTART, but is not used for that access point. Rather, it is used in the carrier frequency selection for the next access point. For example, if the first two selected carrier frequencies for a particular access point are f₁ and f₂, then the next candidate for selection f₃ is analyzed (by way of the UNWANTED FREQ VECTOR) to determine what affect any intermodulation products of (f₁ and f₃) and (f₂ and f₃) would have on the currently selected carrier frequencies (i.e., f₁, f₂) for that access point. If such analysis of the UNWANTED FREQ VECTOR yields information that f₃ is unsuitable and will produce intermodulation products which will detrimentally affect or interfere with f₁ and f₂, then f₃ will not be chosen for the access point. However, f₃ might be useful for another subsequent access point. Therefore, if intermodulation products for f₃ are indicated in UNWANTED FREQ VECTOR as undesirable (block 82), then per block 84, the starting frequency for the next access point is chosen as f₃. This continues until a carrier frequency is selected which does not cause undesirable intermodulation products for that access point. When the unselected carrier frequency being considered does not generate an undesired intermodulation product, that carrier frequency is assigned to the successive sector of the current access point (block 86). Inner loop 66 repeats until carrier frequencies have been assigned to all sectors of the access point (i.e., COUNT2=Nₛ).

Turning to the specifics of FIG. 3, in block 80 inner loop 66 is entered and the next carrier frequency in FREQ VECTOR is selected and analyzed/compared with respect to those frequencies in UNWANTED FREQ VECTOR. Next, in block 82, the result of the comparison of next carrier frequency and those frequencies in UNWANTED FREQ VECOTR is used to control processing in algorithm 60.

If the next carrier frequency in FREQ VECTOR intermodulates with one or more of those carrier frequencies previously selected for the current access point (i.e., those carrier frequencies in TEST FREQ VECTOR) such that such intermodulation products appear in UNWANTED FREQ VECTOR, block 84 is entered. In block 84, an attempt to assign that carrier frequency to the next access point is made by assigning that carrier frequency to FSTART. Algorithm 60 then continues, as before, from block 80.

If the next carrier frequency in FREQ VECTOR does not generate an intermodulation product with respect to those selected carrier frequencies in TEST FREQ VECTOR, as reflected in UNWANTED FREQ VECTOR, block 86 is entered. In block 86, that carrier frequency is then selected and assigned to the TEST FREQ VECTOR for an incremented COUNT2 (COUNT2 plus 1), corresponding to the next sector in the current access point, and COUNT2 is then incremented. Algorithm 60 then continues at block 88. In block 88, it is determined whether COUNT2 is equal to the number of sectors in the access point, or Nₛ, and therefore whether all of the sectors for a particular access point are addressed.

If COUNT2 is not equal to Nₛ, algorithm 60 continues as before from block 80, completing inner loop 66. Thus, inner loop 66 continues until carrier frequencies are assign to all sectors of the current access point. However, if all sectors of the current access point have been assigned a carrier frequency and COUNT2 is equal to Nₛ, algorithm 60 proceeds to block 90.

In block 90, it is determined whether COUNT1 (i.e., the access point count) is equal to the number of access points in the WLAN, or MAP. If COUNT1 is not equal to the number of access points in the WLAN, algorithm 60 continues on to block 92. In block 92, COUNT1 is incremented by one and algorithm 60 continues control, as before, from block 74 assigning carrier frequencies to the sectors of the remaining access points. However, if COUNT1 is equal to the number of access points in the WLAN, algorithm 60 continues to block 94.

In block 94, it is determined whether FSTART is empty. If FSTART is not empty, algorithm 60 continues, as before, from block 72. However, if FSTART is empty, and all sectors of all access points in the WLAN have been assign a carrier frequency such that intermodulation products are reduced, algorithm 60 stops. Those skilled in the art will appreciate that carrier frequency pairs that give rise to intermodulation products may be assigned by algorithm 60 to different access points such that path losses are exploited, i.e., spatial diversity. Such assignments thereby reduce intermodulation products among the carrier frequencies.

While the present invention has been illustrated by the description of the embodiments thereof, and while the embodiments have been described in considerable detail, it is not the intention of the applicants to restrict or in any way limit the scope of the appended claims to such detail. For example, it will be understood that practically any frequency increment and any frequency band may be used as desired without departing from the spirit of the present invention. Further, practically any modulation scheme that is susceptible to intermodulation products, e.g., frequency modulation, time division multiple access (TDMA), etc., may also be used without departing from the spirit of the present invention. Moreover, a WLAN may include practically any number of access points, each having practically any number of sectors. It will also be understood that principles of the present invention apply to cellular, as well as other, communications systems using equally spaced carrier frequencies and modulation schemes susceptible to intermodulation. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicants' general inventive concept.

What is claimed is

1. A wireless network comprising:
a first plurality of wireless access points, each having second pluralities of sectors defined by respective directional antennas;
the sectors within the wireless access points operating using carrier frequencies;
the carrier frequencies of a particular access point being selected to reduce interfering intermodulation products among the carrier frequencies at that particular access point.

2. The wireless network of claim 1, wherein the carrier frequencies are equally spaced carrier frequencies.

3. The wireless network of claim 1, wherein a carrier frequency selected for one access point is unsuitable for use in another access point.

4. The wireless network of claim 1, wherein the carrier frequencies of the sectors of a particular access point are such that intermodulation products of at least two of the carrier frequencies do not fall on the other carrier frequencies of the sectors.

5. The wireless network of claim 1, further comprising a hub couple to the access points for communicating therewith.

6. A wireless access point configured for operation in a wireless network, the access point comprising:
a plurality directional antennas defining a plurality of sectors;
the sectors within the access point operating using carrier frequencies;
the carrier frequencies being selected to reduce interfering intermodulation products among the carrier frequencies in the access point.

7. The wireless access point of network of claim 6, wherein the carrier frequencies are equally spaced carrier frequencies.

8. The wireless access point of claim 6, wherein the carrier frequencies are such that intermodulation products of at least two of the carrier frequencies do not fall on the other carrier frequencies of the sectors.

9. The wireless access point of claim 6, wherein the plurality of sectors includes one of three and four sectors.

10. A wireless access point comprising:
a plurality of defined sectors;
at least one carrier frequency associated with each sector;
the associated carrier frequencies of at least two sectors having intermodulation products which do not fall at carrier frequencies of other sectors.

11. The wireless access point of claim 10, wherein the carrier frequencies are equally spaced carrier frequencies.

12. A method of assigning carrier frequencies to a sectorized access point in a wireless network comprising:
initially selecting a plurality of carrier frequencies for some of a plurality of sectors of the access point;
selecting subsequent carrier frequencies for other of the plurality of sectors of the access point;
the subsequent selections being based on how the intermodulation products of a subsequently selected carrier frequency affect the initially selected carrier frequencies.

13. The method of claim 12 further comprising:
selecting a first carrier frequency;
selecting a second carrier frequency; and
selecting a third carrier frequency, wherein the third carrier frequency does not form intermodulation products with either the first or the second carrier frequencies to produce a frequency at either the first or second carrier frequency.

14. The method of claim 12, wherein said subsequent selection includes comparing a carrier frequency to a list of unwanted carrier frequencies.

15. The method of claim 12, wherein the carrier frequencies are equally spaced.

16. The method of claim 12, wherein the subsequent selection of a carrier frequency is based on whether that carrier frequency forms intermodulation products with any of the initially selected carrier frequencies, which intermodulation products are at or near an initially selected carrier frequency.

17. The method of claim 12, further comprising selection subsequent carrier frequencies until a carrier frequency is selected for each sector of the access point.

18. A method of installing a wireless network comprising:
positioning a plurality of access points, each having a plurality of sectors;
assigning carrier frequencies to sectors of each access point to reduce intermodulation product interference among the carrier frequencies in the sectors of the access points.

19. A method of claim 18, further comprising:
initially selecting and assigning carrier frequencies for some sectors of an access point;
selecting a subsequent carrier frequency for the access point;
determining whether the subsequent carrier frequency interacts to form intermodulation products which are at or near initially selected carrier frequencies;
based upon such determination, assigning that carrier frequency to one of a sector of the access point and to another access point.

20. The method of claim 18, further comprising rejecting a carrier frequency for assignment to an access point sector based upon that carrier frequency forming intermodulation products at or near another carrier frequency for that access point.

21. The method of claim 20, further comprising assigning the rejected carrier frequency to another access point.

22. The method of claim 18, further comprising comparing carrier frequencies to a list of unwanted carrier frequencies for the purpose of assigning.

23. The method of claim 18, further comprising assigning carrier frequencies for all of the sectors of all of the access points in the network.

24. The method of claim 18, wherein the carrier frequencies are equally spaced.

25. A method of assigning equally spaced carriers frequencies to a sectorized access point of a wireless network comprising:
determining undesired intermodulation products of the equally spaced carriers frequencies;
selecting a first carrier frequency to be assigned to a first sector in the wireless access point;
selecting a second carrier frequency to be assigned to a second sector in the wireless access point;
selecting a third carrier frequency to be assigned to a third sector in the wireless access point;
comparing the intermodulation products of the first, the second and the third carrier frequencies to the undesired intermodulation products of the equally spaced carriers frequencies;
assigning the selected carrier frequencies to sectors of the access point based on such comparison.

26. The method of claim 25, further comprising:
assigning the first and second carrier frequencies to the respective sectors;
based on the comparison, assigning or not assigning the third carrier frequency to the respective sector.

27. The method of claim 25 further comprising rejecting at least one of the first, second and third carrier frequencies for the access point based on the comparison, and selecting the rejected carrier frequency for use with another access point.
